(19) United States
(12) Patent Application Publication
(10) Pub. No.: US 2005/0136214 A1
(43) Pub. Date: Jun. 23, 2005

(54) Mounting board

(75) Inventor: Ronald W. Most, River Falls, WI (US)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 10/739,836

(22) Filed: Dec. 18, 2003

(51) Int. Cl. B32B 3/06

(52) U.S. Cl. 428/100

(57) ABSTRACT

The invention is a mounting board comprising a mounting surface. The mounting surface includes a polymeric backing an a plurality of mushroom shaped hooks extending from a first side of the backing. The mounting surface is configured to provide a mounting area large enough to allow the securing of multiple items. The mounting surface has an opacity of less than 50 percent. A stiff substrate is secured to a second side of the backing.

### BACKGROUND AND FIELD OF THE INVENTION

The invention is an organizing surface that can be used in a vertical position. More specifically, the invention is a vertically mounted surface that allows multiple items to be secured to a variety of points on the surface.

It is common to use cork boards or adhesive covered boards for holding in place a variety of small objects of limited weight in a vertical position (e.g. mounted on a wall), in either an office or in a home setting. In particular, cork boards and adhesive covered boards are useful for holding very lightweight objects such as papers and photos. Adhesive covered boards are limited in the weight of the object which can be held in place due to the required repositionability or “release” of the adhesive used on the board. In the case of cork boards, typically a pin or “tack” is used to secure the object or item to the board by pushing the tack through the item and into a cork substrate mounted on a wall. Using this configuration, the object (such as a photograph) typically is damaged, since a hole is formed by the tack as it is pushed through the object in order to secure the object to the board. Additionally, the tack can only hold objects of a certain weight on the board, since at a certain low weight, the cork in the board compresses, allowing the tack to slide out and the object to fall.

Felt boards typically employ a hook and loop fastening system, where multiple “fishhook” shaped filaments project from a board mounted to the wall, and a mating “loop” of filament is integral to or secured to the item. When the fishhook filament and the loop filament are engaged, the object is suspended in place. This type of securing system is limited in the size of object that can be secured, since at a certain weight, the fishhook filament can bend and disengage from the object before the object falls off of the board. The level of weight that can be supported by the felt board is limited by the number of hooks and loops which can be engaged, due to the surface area of the board as well as the surface area of the object. Additionally, since the density of the fishhook filament on the board must be high to provide adequate adhesion, it is not feasible to print graphics or images behind the fishhook filaments, since the fishhook filaments obscure the viewing of any such graphics or images to a large degree.

Peg boards are stiff substrates, such as particle or fiber board which have holes passing through them in a spaced and consistent pattern. “Racks” or other inserts are secured to the board by positioning a portion of the rack through the spaced holes in such that the portion extending through the board has a bend extending upwardly or downwardly on the back side of the board, securing the rack in place. The portion of the rack not extended through the holes can then be used to suspend items in place. The configuration of how and where the object is held is limited due to the placement of the peg holes as well as the configuration of the rack. Additionally, the rack must be able to extend behind the board, requiring a space between any surface the peg board is mounted to in order to mount the rack or hooks in place.

Mushroom shaped hook fastening systems have been found to have desirable optical clarity and holding strength characteristics. Mushroom shaped fastening systems have not previously been used over a large surface area to provide a large mounting surface for many items.

There exists a need for a wall board that can hold a variety of objects in any configuration such as framed pictures, car keys, cell phones, office products, tools, etc. and that can additionally be aesthetically attractive for the home and office environment.

### SUMMARY OF THE INVENTION

The invention is a mounting board which comprises a mounting surface. The mounting surface includes a polymeric backing and a plurality of mushroom shaped hooks extending from a first side of the backing. The mounting surface is configured to provide a mounting area large enough to allow the securing of multiple items. The mounting surface has an opacity of less than 50 percent. A stiff substrate is secured to a second side of the backing.

### BRIEF DESCRIPTION OF THE DRAWINGS

The present invention is further described in reference to the accompanying drawings where like reference numerals refer to like parts.

FIG. 1 is a front view of one embodiment of the inventive mounting board.

FIG. 2 is an isometric view of a portion of one embodiment of the mounting surface of the inventive mounting board.

FIG. 3 is a partial cross-sectional view of one embodiment of the inventive mounting board as taken along line 3-3 of FIG. 1.

FIG. 4A is a front view of one embodiment of a first exemplary item that may be mounted to the inventive mounting board.

FIG. 4B is a front view of one embodiment of a second exemplary item that may be mounted to the inventive mounting board.

FIG. 4C is a side view of a test plate configuration used in the cleavage test.

FIG. 4D is a side view of a test plate configuration used in the cleavage test.

FIG. 5 is a schematic view of a first method for forming an extruded hook and backing used to form the mounting surface of the inventive mounting board.

FIG. 5A is a cross-sectional schematic view of one embodiment of a hook from the inventive mounting board.

FIG. 6 is a schematic view of a further method used in forming an extruded hook and backing used to form the mounting surface of the inventive mounting board.

### DETAILED DESCRIPTION OF THE INVENTION

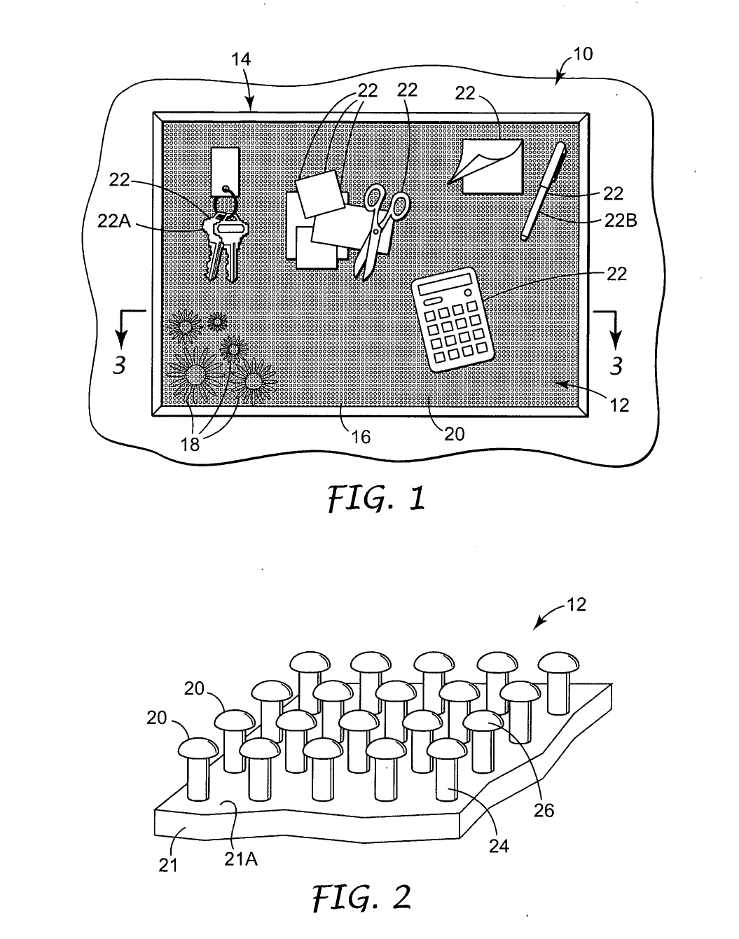

An embodiment of the current inventive mounting board is shown generally at 10 in FIG. 1 (i.e. as a bulletin board). Mounting board 10 includes mounting surface 12 and frame 14. Frame 14 is illustrated as completely surrounding mounting surface 12, but could alternately extend along a portion of periphery 16 of mounting surface 12, or be omitted from mounting board 10 entirely. Display graphics 18 may also be included as part of mounting board 10. In one preferred embodiment of the invention, display graphics 18 are disposed behind mounting surface 12, although display graphics 18 may alternately be printed directly on mounting surface 12. Mounting surface 12 is large enough to provide enough area to allow multiple items 22 to be secured to mounting board 10. In one embodiment, mounting surface 12 covers an area of at least about 4 in² (26 cm²), preferably covers an area of at least about 80 in² (516 cm²), and more preferably covers an area of at least 864 in² (5574 cm²).

FIG. 2 illustrates a partial view of mounting surface 12. Mounting surface 12 includes a plurality of mushroom shaped projections (or “hooks”) 20 and a substantially continuous backing 21. Hooks 20, extend generally perpendicularly from backing 21. In one embodiment, hooks 20 are disposed in a generally regular array. Backing surface 21A extends between individual hooks 20 and is preferably smooth. In one preferred embodiment, backing 21 and hooks 20 are formed from a substantially transparent film resin. In one embodiment, mounting surface 12 has an overall opacity of less than about 50 percent, preferably less than about 30 percent, and more preferably less than about 15 percent. Measurements for opacity may be conducted using standard measurement techniques, as known in the art. For example, measurements may be made on a PERKINELMER LAMBDA 900 Spectrophotometer (available from PerkinElmer, Inc., Wellesley, Mass. fitted with a PELA-100 integrating sphere accessory (available from PerkinElmer). The sphere complies with ASTM methods E903, D1003, E308, et al. as published in “ASTM Standards on Color and Appearance Measurement”, Third Edition, ATM, 1991. Measurements can be performed in general accord with ASTM Practice E1164. Opacity data can be measured using standard near-normal reflectance geometry in a six inch (150 mm) diameter integrating sphere consistent with ASTM D1003. The calculation of Opacity can be expressed as C₁₀₀=100*R₀/R₁₀₀. Total Luminance Reflectance measurements can be performed by taking samples backed by a >99 percent reflective white plate to obtain R₁₀₀ and again measured with a <0.05 percent light trap to obtain R₀. The calculation of C₁₀₀ parallels the calculation of C_{0.89} as described in ASTM D589-97.

In one preferred embodiment, mounting surface 12 has an average line resolution (or average line intensity) at the 20%-80% intensity of a distance of about 0.668 mm or less when taken at a Normal viewing angle using Normal illumination. In an additional preferred embodiment, mounting surface 12 has an average line resolution at the 20%-80% intensity of a distance of about 0.631 mm when taken at a 30 degree viewing angle using 45 degree illumination. Line intensity may be tested using standard methods known in the art, for example as detailed in “Timothy Corle, Gordon Kino, Confocal Scanning Optical Microscopy and Related Imaging Systems, Academic Press, 1996.”

Items 22 (see FIG. 1) are secured to mounting surface 12 through an interlocking of hooks 20 with a compatible material that is either secured to or is integral with each item 22. The mushroom-type hooks of the current invention are preferably designed so that opposing hooks can engage. This type of hook is sometimes referred to as “hermaphroditic” because the hooks have both male and female characteristics when intermeshed. One exemplary hook system which may be used in the current invention is disclosed in U.S. Pat. No. 6,076,238 incorporated by reference in its entirety herein.

Hooks 20 are typically of uniform height, although hooks 20 may vary in height, and may also be any desired height, cross section, or head shape. Exemplary heights of the hooks, measured from backing surface 21A to the bottom of head 26 of hook 20, are in the range of about 0.002 in to about 0.500 in. (about 0.005 cm to about 1.27 cm). Preferred heights of the hooks, measured from backing surface 21A to the bottom of head 26 are in the range of about 0.025 in. to about 0.075 in. (about 0.064 cm to about 0.191 cm).

Exemplary heights of heads portion 26 of hooks 20, measured from the bottom of head 26 to the top of head 26, are in the range of about 0.002 to about 0.215 in. (about 0.005 to about 0.546 cm). Preferred heights of heads 26 of the hooks 20, measured from the bottom of head 26 to the top of head 26, are in the range of about 0.010 in. to about 0.030 in. (about 0.025 cm to about 0.076 cm). Alternatively, as mentioned previously, the heights of the hooks 20 may vary on the mounting surface 12.

Exemplary diameters of stem portion 24 of hoods 20 are in the range of 0.003 in. to 0.070 in. (about 0.008 cm to about 0.178 cm.) Most preferred diameters of the stems are in the range of 0.008 in. to 0.016 in. (about 0.020 cm to about 0.041 cm). Stems 24 may be cylindrical or tapered. Preferred diameters of heads 26 at their outermost periphery are in the range of about 0.005 in. to about 0.150 in. (about 0.013 cm to about 0.381 cm.). More preferred diameters of heads 26 at their outermost periphery are in the range of about 0.018 in. to about 0.030 in. (about 0.046 cm to about 0.076 cm.).

The head density of mounting surface 12 is equal to the planar area occupied by heads 26 divided by the total area of the top surface of backing 21. The head density may be selected based on the desired use. Preferably, the head density is selected such that engagement between a pair of opposing hooks 20 can engage, yet there is a sufficient density so that strong engagement is achieved. The head density for mounting surface 12 is preferably in the range of about 14 percent to about 45 percent. More preferably, the head density is in the range of about 30 percent to about 35 percent.

The number of hooks 20 in a given area may be any number, selected based on the size of the hooks 20 and head portions 26 engaging stems. One preferred density of engaging hooks is in the range of about 7 hooks/in² to about 22959 hooks/in² (1 hooks/cm² to 3560 hooks/cm²). A more preferred density of hooks is in the range of about 285 hooks/in² to about 804 hooks/in² (44 hooks/cm² to 125 hooks/cm²).

The preferred distribution of the hooks would include a plurality of engaging stems located in unordered arrangements, which repeat on a substrate. A preferred embodiment of mounting surface 12 provides a plurality of repeating unordered arrangements of the mushroom shaped hooks, where the arrangements repeat in more than one direction. The unordered arrangements of the engaging hooks allow pairs of opposing hooks to engage. Additionally, the unordered arrangements of hooks allow opposing hooks to engage with a relatively constant engagement force, and a relatively constant disengagement. force.

The stiffness of the hooks is related to the diameter, height, and material of the hook. For hook stem portion 24 diameters in the range of about 0.012 in to about 0.016 in. (about 0.030cm to about 0.041 cm) and stem 24 heights in the range of about 0.015 in to 0.051 in. (0.038 cm to 0.0130 cm.), the flexural Modulus is preferably in the range of about 25,000 psi to about 2,000,000 psi (172,250 kPa to 13,780,00 kPa). For stem 24 diameter of about 0.014 in (about 0.0356 cm) and a stem 24 height of about 0.037 in. (about 0.094 cm.) a more preferred flexural Modulus is approximately 200,000 psi (1,378,000 kPa).

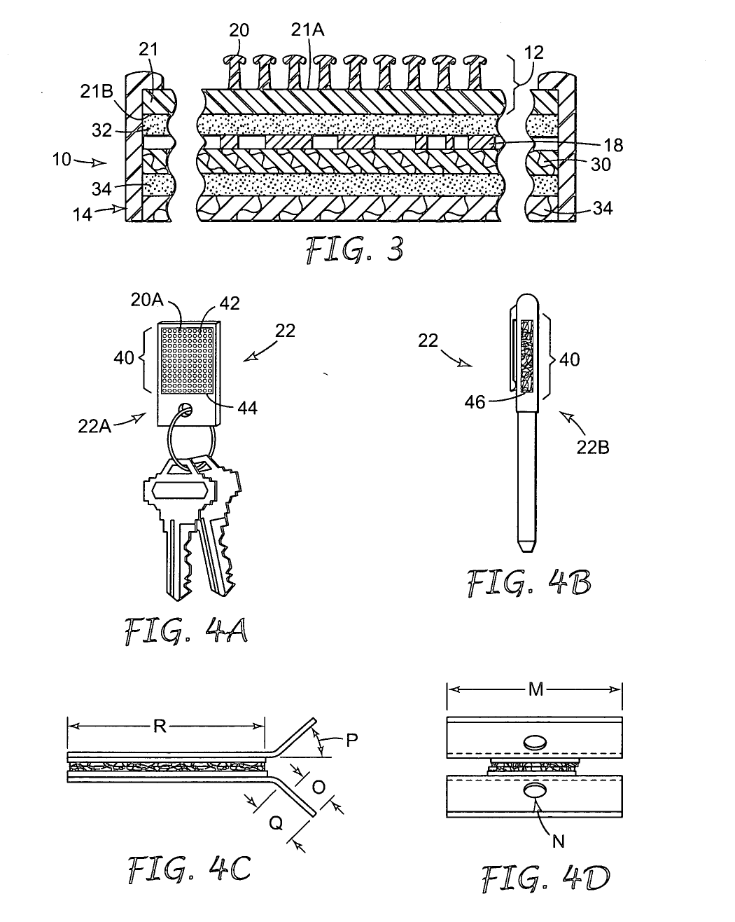

FIG. 3 illustrates a partial cross-sectional view of the inventive mounting board 10 as taken along line 3-3 of FIG. 1. In the illustrated embodiment, mounting board 10 includes substrate 30 upon which display graphics 18 are printed (e.g. a poster). Substrate 30 is adhered with adhesive 32 to bottom face 21B of backing 21. Any number of other alternatives for creating display graphics 18 below mounting surface is contemplated by the current invention. For example, display graphics 18 can be printed directly on bottom face 21B of backing 21. Other bonding techniques could also be used to join display graphics 18 to backing 21. Printing on bottom face 21B of backing 21 could be enhanced by coating or co-extruding an ink receptive layer onto the backing 21, or by treating bottom face 21B of the backing 21 by corona, flame or other standard treatments or techniques.

A stiff base 34 may also be included as part of inventive mounting board 10. Base 34 can be formed of any number of materials which act to stiffen the overall mounting board 10, such as wood, plastic metal and sheetrock, among others. As illustrated, base 34 can be secured to substrate 30 using a layer of adhesive 34, however, any number of methods known in the art to secure the base 34 in place is contemplated (e.g. mechanical fasteners). It should be understood that while the illustrated embodiment includes display graphics 18 as part of the inventive mounting board 10, alternatively, no graphics may be incorporated. Additionally, other layers may also be included as part of the inventive mounting board 10 (not illustrated). For example, adhesive and ink primer coatings may be included in the inventive mounting board 10.

Items 22 (illustrated in FIG. 1) can be provided with a portion of material on its surface that is engageable with mounting surface 12. A mating patch 40 maybe integral to each item (e.g. cloth) or may be a separate piece of material secured to the surface of the item. This “separate” mating patch 40 can be laminated by standard adhesive, heat or mechanical methods (sewing or needling) to item 22. Examples of engageable items are illustrated in FIGS. 4A and 4B. FIG. 4A illustrates a keychain 22A including mating patch 40 of hooks 42 (similar or identical to those on mounting surface 12) extending from a continuous mating backing 44 that is secured to keychain 22A. FIG. 4B illustrates a pen 22B incorporated a patch 40 of loop material 46 (e.g. woven or knitted) secured to pen 22B. Many types of mating material are contemplated which can be mated to mounting surface. This material may be secured to or integral with items 22 such as standard fibrous loop type material including non-woven material, woven or knitted loop (as illustrated), any of which may or may not be provided with a continuous backing.

In one embodiment, the distribution and hook configuration of the mounting surface provides for Dynamic shear force, 90° Peel Force and Engagement/Disengagement Force values as shown in Table 1.

TABLE 1

| | Mounting surface | |
|---|---|---|
| | mated to same hook | Mounting surface |
| | configuration | mated to loop |
| | mating patch | material patch. |
| Average Dynamic Shear | at least about 40 | at least about 135 |
| Force | lb_{f}/in² (275 kN/m²) | lb_{f}/in² (931 kN/m²) |
| Average 90° Peel Force | at least about 1.7 | at least about 3.1 |
| | lb/in width (0.3 | lb/in width (0.55 |
| | kg/cm width) | kg/cm width) |
| Average Engagement | about 30 lb_{f}/in² | about 1.0 lb_{f}/in² |
| Force | or less (186 kN/m²) | or less (6.9 kN/m²) |
| Average Disengagement | about 40 lb_{f}/in² | about 20 lb_{f}/in² |
| Force | or less (276 kN/m²) | or less (138 kN/m²) |
| Average Cleavage | at least about 4.0 | at least about 6.1 |
| Strength | lb/in width (0.7 | lb/in width (1.1 |
| | kg/cm width) | kg/cm width) |

Samples of hooks substantially identical mounting surface and samples of loop material (such as, for example, the loop portion of the SCOTCHMATE® brand SJ3571 hook and loop fastener, available from 3M Company, St. Paul, Minn.) attached to the mounting surface (such as, for example, 3M Brand™ DUAL LOCK™ Low Profile Fastener No. SJ4580, available from 3M Company, St. Paul, Minn.) may be tested for a dynamic shear force value, 90° peel force value, engagement force value and disengagement force value in accordance with the test method described below.

Dynamic Shear Testing of Mating Patch to Mounting Surface

The dynamic shear test measures the amount of force it takes to remove a mating patch, measuring 1 inch×1 inch (2.54 cm×2.54 cm), that is attached to a piece of mounting surface, measuring 1 inch×1 inch (2.54 cm×2.54 cm), when they are separated by pulling them in directions 180 degrees from each other. The bottom (non-mating) side of a 1 inch×1 inch (2.54 cm×2.54 cm) sample of mounting surface is secured to a 2 inch×3 inch (5.08 cm×7.62 cm) anodized aluminum test panel. The mounting surface sample is disposed about 0.5 inch (1.27 cm) from one longitudinal end of the test panel, and 0.5 inch (1.27 cm) from each transverse side of the test panel, so as to “center” the mounting surface sample at 1 inch (2.54) from one end of the test panel. A mating patch of 1 inch×1 inch (2.54 cm×2.54 cm) is secured to a 2 inch×3 inch (5.08 cm×7.62 cm) anodized aluminum test panel. The mating patch sample is disposed about 0.5 inch (1.27 cm) from one longitudinal end of the test panel, and 0.5 inch (1.27 cm) from each transverse side of the test panel, so as to “center” the mating patch sample at 1 inch (2.54) from one end of the test panel. The one test panel and mating patch is placed on top of the other test panel and mounting surface sample (face to face) to achieve a 1 inch×1 inch engagement area, with the longitudinal ends of each test panel not containing the mounting surface and mating patch disposed at 180 degrees from each other (i.e. not “mirrored) . The engaged specimen is pressed together using finger pressure, then the plate with the mating patch is twisted approximately 20 degrees in each direction to more fully engage. The mated mounting surface and mating patch sample are placed on a flat surface. An 8 pound (3.6 kg) steel bar is placed over the engaged portion of the sample and roll a 4-½ pound (2 kg) roller over a 2 inch (5.08 cm) span over the sample for 6 passes (3 cycles) using at a rate of approximately 12 inches (30.5 cm) per minute.

The aluminum test plate having the affixed mating patch is secured into upper jaw of a tensile tester, (such as an INSTRON™ Model 1122, manufactured by Instron Corporation, Canton, Mass.). The metal plate having the affixed mounting surface is placed into the lower jaw and clamped securely such that the tensile tester pulls the mounting patch in a direction 180 degrees from the direction the mounting surface is pulled. The shear force is recorded at a tensile tester crosshead speed of 12 inches (30.5 cm) per minute.

90 Degree Peel of Testing of Mating Patch to Mounting Surface

The peel test measures the amount of force it takes to remove a mating patch measuring 1 inch (2.54 cm)×1 inch (2.54 cm) that is attached to a piece of mounting surface while peeling the mating patch from the mounting surface at a 90 degree angle and constant peel rate. A 1 inch×1 inch (2.54 cm×2.54 cm) sample of mating patch material is placed on a mounting surface sample. The overlapped specimen is rolled by hand, once in each direction, using a 4.5 pound (100 gram) roller at a rate of approximately 12 inches (30.5 cm) per minute, to engage the mounting surface sample and the mating patch.

The mating patch was then place into the lower jaw of a tensile tester (such as an INSTRON™ Model 1122, manufactured by Instron Corporation, Canton, Mass.). Without pre-peeling the sample, the leading edge is placed in to the upper jaw of the tensile tester. The tensile tester is then engaged. The peel force of removing the mating patch from the piece of mounting surface is recorded, while being maintained at a 90 degree angle, at a crosshead speed of 12 inches (30.5 cm) per minute.

Engagement and Disengagement Test

This test determines the force needed in pounds for the disengagement and engagement of a mating patch measuring 1 inch (2.54 cm)×1 inch (2.54 cm) that is attached to a piece of mounting surface while peeling the mating patch from the mounting surface at a 90 degree angle and constant peel rate. A 1+/−1/64 inch×1+/−1/64 inch (25.4+/−0.4 mm×25.4+/−0.4 mm) sample of mating patch material is placed on a mounting surface sample 1+/−1/64 inch×1+/−1/64 inch (25.4+/−0.4 mm×25.4+/−0.4 mm). Each sample is mounted to the center of a separate test block. One test block is mounted to a stationary jig (such as a Chatillon model LTS Test Stand or equivalent, Chatillon Company, Greensboro, N.C.) and one test block is mounted to a digital force gauge (such as a Chatillon Model DFG digital force gauge, Chatillon Company, Greensboro, N.C.). The mating patch and the mounting surface sample are aligned to face each other (face to face) and the clamps of the digital force gauge (moving jig) and the test stand (stationary jig) are centered. The Digital Force Gauge is set to “lb.”, “Norm”, and compression mode, and zeroed. The specimens are engaged at about 8 inches+/−1 inch per. minute (305 mm+/−51 mm per minute). When the mating patch consists of hooks substantially identical to the hooks of the mounting surface, the force required to engage the specimens will suddenly decrease when engagement is achieved and an audible click may be heard. The engagement force is recorded. The Digital Force Gauge is then set into the tension mode and zeroed. The specimens are disengaged at about 8 inches+/−1 inch per minute (305 mm+/−51 mm per minute). The disengagement force is recorded.

Cleavage Test

This test determines determines the cleavage strength of a mating patch measuring 1 inch±1/16 (25.4 mm±1.6 mm)×2.25 inch±1/16 (57.2 mm±1.6 mm) to a dynamic cleavage force that is attached to a piece of mounting surface measuring 1 inch±1/16 (25.4 mm±1.6 mm)×2.25 inch±1/16 (57.2 mm±1.6 mm). Two clean, bare aluminum plates are required. For clarification purposes, FIGS. 4C and 4D are provided to illustrate the configuration of the aluminum test plates. Both plates shall be 2″ (illustrated by reference letter M)×3″ and have a single ¼″ diameter hole (illustrated by reference letter N) centered along the 2″ width of the plate and located ⅜″ from centerline (illustrated by reference letter O) to the plate's edge and a 45 degree bend (illustrated by reference letter P) located 9/16″ from the end of the plate (illustrated by reference letter Q).

The mating patch is adhered to one aluminum test plat and the mounting surface sample is adhered to the other aluminum test plate. Both the mating patch and surface sample should be oriented with the end even with the unbent edge of the respective test plate and centered on the 2″ width of the test plate, extending forward towards the bent portion (illustrated by reference letter R). Each plate should be place in a mirrored overlapping configuration such that the mounting surface sample is overlapped with the mating patch and such that the angled portion of the plates are disposed at the same end forming the test specimen. The mating patch and mounting surface sample are engaged by carefully aligning them on top of one another and using increasing finger pressure to press the mating patch against the mounting surface sample. When the mating patch consists of hooks substantially identical to the hooks of the mounting surface, an audible click may be heard. A hook is slid through the hole in one of the test plates and the hook clamped in the lower, fixed jaw of a tensile tester (such as an INSTRON™ Model 1122, manufactured by Instron Corporation, Canton, Mass.). Enough clearance should be provided so that the test plate can freely rotate about the hookias the,test is being conducted. Holding the test specimen approximately horizontal and perpendicular to the clamping plane of the jaws, another hook is looped through the hole in the remaining upper plate. The second hook is clamped in the movable jaw of the tensile tester. Enough pre-tension should be provided to the specimen to maintain it in a roughly horizontal position when external support is removed. The tensile tester is engaged at a crosshead speed of 12 inches (30.5 cm) per minute. The cleavage strength is the maximum dynamic force applied to the sample when removing the mating patch from the piece of mounting surface is recorded.

Method for Forming Mounting Surface

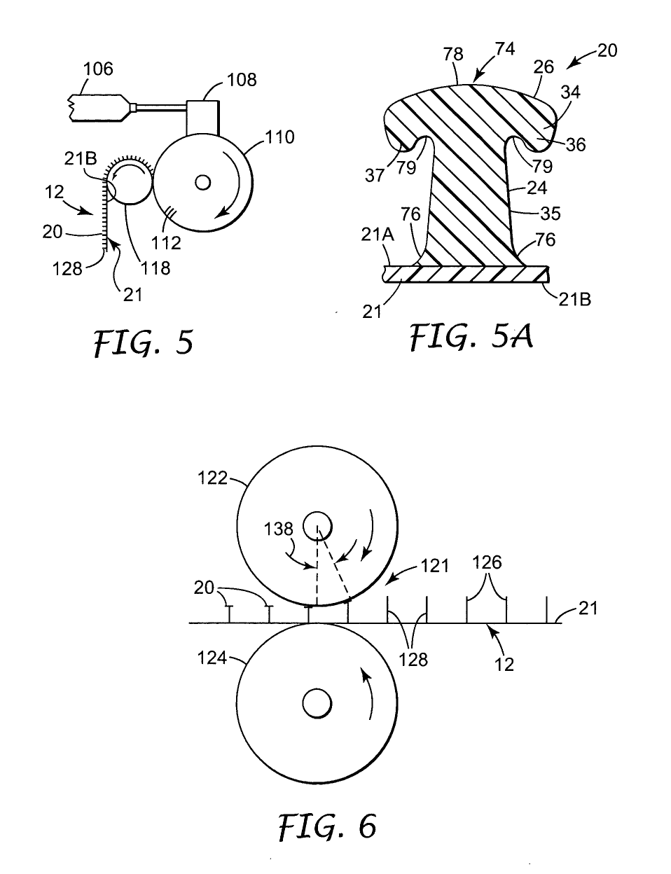

A first exemplary method of forming mounting surface 12 for use in inventive mounting board 10 is by extruding a thermoplastic resin through a die onto a continuously moving mold surface with cavities. One exemplary process is illustrated in FIG. 5. A feed stream of preselected thermoplastic resin is fed by conventional means into extruder 106 which melts the resin and moves the heated resin to die 108. Die 108 extrudes the resin as a wide ribbon of material onto a mold surface 110, e.g., a cylinder, having an array of mold cavities 112 in the form of elongated shaped holes. The mold cavities can be connected to a vacuum system (not shown) to facilitate resin flow into the mold cavities. This could require a doctor blade or knife to remove excess material extruded into the interior face of the mold cylinder. Mold cavities 112 preferably terminate in the mold surface having an open end for entry of the liquid resin and a closed end. In this case, a vacuum could be used to at least partially evacuate mold cavities 112 prior to entering die 108. Mold surface 110 preferably matches that of die 108 where they are in contact to prevent excess resin being extruded out, e.g., the die side edges. The mold surface and cavities can be air or water cooled, or the like, prior to stripping the integrally formed backing 21 and upstanding projection elements 128 (e.g. hooks) from the mold surface such as by a stripper roll 118. This provides a continuous web of mounting surface 12. Alternatively, upstanding projection elements 128 could be formed on a preformed backing or the like by extrusion molding or other known techniques.

In the embodiment illustrated, the nip is formed by extruder die 108 and roll 110 but alternatively the polymer could be extruded between two roll surfaces or the like. The nip or gap is sufficient that backing 21 is also formed over the cavities. Backing 21 preferably has a smooth surface along bottom face 21B back but could have a textured or rough surface. The formed mounting surface 12 material has projection elements 128 projecting from backing 21 which mounting surface 12 material is removed from the mold surface by a take-up device 118. A vacuum can be used to evacuate the cavities for easier extrusion into the cavities.

Cavities 112 could be in the shape of final mushroom shaped hooks 20 as disclosed, for example, in U.S. Pat. No. 6,174,476. In this embodiment, cavities 112 are in the shape of final hook 20, and a generally continuously tapered hook shaped projection element 128 is pulled from continuously tapered hook cavities, directly resulting in hooks 20. Alternatively, the extruded mounting surface 12 could also provide a web of material provided with projection elements 128 only partially formed into hooks, or as shown in FIG. 6, as unformed projection elements 128. Tip portion 126 of these projection elements 128 (or the tips of partially formed hooks) then need to be subsequently formed into finished hooks 20. Forming the hooks may be accomplished by deforming tip portions 126 under heat and pressure. The heat and pressure could be applied sequentially or simultaneously. In one method, heat and pressure are selectively applied to tip portion (or distal end) 126 in nip 121. In this case, nip 121 is provided which has at least one first heated surface member 122 and at least one second opposing surface member 124. The final mounting surface 12 has formed hook heads 20 formed from projection elements 128. The heated calender roll 122 contacts a predetermined portion of tip portion 126 of projection elements 128 projecting upward from backing 21. The roll temperature will be that which will readily deform tip portion 126 under pressure created by the nips in compression zone 138 without causing resin to stick to roll 122 surface. Roll 122 surface can be treated with release coatings resistant to high temperature to allow for higher temperatures and/or longer contact times between the tip portion 126 and the heated roll 122.

One embodiment of an exemplary hook 20 is illustrated in FIG. 5A. The hook 20 comprises a thin strong flexible film-like backing 21 having generally parallel backing surface (upper face) 21A and bottom face 21B, hook 20 projects from upper face 21A of backing 21. Backing 21 can have planar surfaces or surface features as could be desired for tear resistance or reinforcement. Hook 20 comprises stem portion 24 attached at one end to backing 21 and preferably has tapered sections 76 that widen toward the backing 21 to increase the hook anchorage and breaking strengths at their junctures with backing 21, and head portion 26 at the end of stem portion 24 opposite backing 21. Sides 34 of head portion. 26 can be flush with sides 35 of stem portion 24 on two opposite sides. Head portion 26 has hook engaging parts or arms 36, 37 projecting past stem portion 24 on one or both sides. Hook 20 preferably has a rounded surface 78 opposite stem portion 24 to help head portion 26 enter between loops if fastened to a loop style mating patch 40. Head portion 26 also has transverse cylindrically concave surface portions 79 at the junctures between stem portion 24 and the surfaces of head portion 26 projecting over backing 21.

Backing 21 is preferably thick enough to allow it to be attached to a substrate by a desired means such as sonic welding, heat bonding, sewing or adhesives, including pressure sensitive or hot melt adhesives, and to firmly anchor hooks 20.

Suitable thermoplastic materials for forming mounting surface 12, however formed, include generally transparent polyolefins such as polypropylenes or polyethylenes, polyamides such as nylon, polyesters such as poly(ethylene terephthalate), plasticized polyvinyl chloride, copolymers and blends thereof, optionally, with other polymers or plasticizers, or the like or coextruded versions.

Other methods for forming mushroom shaped hooks which are known in the art may also be used without departing from the spirit and scope of the invention. For example, the method for forming mushroom shaped hooks shown and described in U.S. Pat. No. 4,290,174, which is incorporated by reference in its entirety herein.

1. A mounting board comprising:
a mounting surface including a polymeric backing and a plurality of mushroom shaped hooks extending from a first side of the backing;
wherein mounting surface is configured so as to have a mounting area large enough to allow the securing of multiple items;
wherein mounting surface has an opacity of less than 50 percent; and
a stiff substrate secured to a second side of backing.

2. The mounting board of claim 1, wherein the mounting surface has an overall opacity of less than about 30 percent.

3. The mounting board of claim 2, wherein the mounting surface has an overall opacity of less than about 15 percent.

4. The mounting board of claim 3 and further comprising: display graphics disposed between the mounting surface and the stiff substrate.

5. The mounting board of claim 3, wherein the mounting surface has a head density of about 14 percent to about 45 percent.

6. The mounting board of claim 5, wherein the mounting surface has a head density of about 30 percent to about 35 percent.

7. The mounting board of claim 1, wherein the mounting surface has an average line resolution at the 20 percent to 80 percent intensity of a distance of about 0.668 mm or less when taken at a normal viewing angle using normal illumination.

8. The mounting board of claim 7, wherein the mounting surface has an average line resolution at the 20 percent to 80 percent intensity of a distance of about 0.631 mm when taken at a 30 degree viewing angle using 45 degree illumination.

9. The mounting board of claim 1, wherein the mounting surface is configured so as to secure a mating patch fastened to one of the items.

10. The mounting board of claim 9 wherein the mating patch is comprised of loop fabric.

11. The mounting board of claim 10 wherein upon mating the mounting surface to the mating patch measuring 1 inch×1 inch (2.54 cm×2.54 cm), the secured item is able to. withstand an average dynamic shear force of at least about 135 lb_{f}/in² (931 kN/m²).

12. The mounting board of claim 10 wherein upon mating the mounting surface to the mating patch measuring 1 inch×1 inch (2.54 cm×2.54 cm), the secured item is able to withstand an average 90 degree peel force of at least about 3.1 lb/in width (0.55 kg/cm width).

13. The mounting board of claim 10 wherein the average engagement force for mating the mounting surface to the mating patch measuring 1 inch×1 inch (2.54 cm×2.54 cm) is about 1.0 lb_{f}/in (6.9 kN/m 2) or less.

14. The mounting board of claim 10 wherein upon mating the mounting surface to the mating patch, the average disengagement force for removing the mounting surface from the mating patch measuring 1 inch×1 inch (2.54 cm×2.54 cm) is about 20 lb_{f}/in² (138 kN/m²) or less.

15. The mounting board of claim 10 wherein upon mating the mounting surface to the mating patch, the average cleavage strength for removing the mounting surface from the mating patch measuring 1 inch×2.25 inches (25.4 mm×57.2 mm) is at least about 6.1 lb/in width (1.1 kg/cm width).

16. The mounting board of claim 9 wherein the mating patch is comprised of mating hooks formed in a substantially identical configuration to the hooks forming the mounting surface.

17. The mounting board of claim 16 wherein upon mating the mounting surface to the mating patch measuring 1 inch×1 inch (2.54 cm×2.54 cm), the secured item is able to withstand an average dynamic shear force of at least about 40 lb_{f}/in² (275 kN/m²).

18. The mounting board of claim 16 wherein upon mating the mounting surface to the:mating patch measuring 1 inch×1 inch (2.54 cm×2.54 cm), the secured item is able to withstand an average 90 degree peel force of at least about 1.7 lb/in width (0.3 kg/cm width).

19. The mounting board of claim 16 wherein the average engagement force for mating the mounting surface to the mating patch measuring 1 inch×1 inch (2.54 cm×2.54 cm) is about 30 lb_{f}/in² (186 kN/m²) or less.

20. The mounting board of claim 16 wherein upon mating the mounting surface to the mating patch measuring 1 inch×1 inch (2.54 cm×2.54 cm), the average disengagement force for removing the mounting surface from the mating patch is about 40 lb_{f}/in² (276 kN/m²) or less.

21. The mounting board of claim 16 wherein upon mating the mounting surface to the mating patch measuring 1 inch×2.25 inches (25.4 mm×57.2 mm), the average cleavage strength for removing the mounting surface from the mating patch is at least about 4.0 lb/in width (0.7 kg/cm width).

22. The mounting board of claim 1, wherein the mounting area of the mounting surface is at least about 80 in² (516 cm²).

23. The mounting board of claim 1, wherein the hooks are configured on the mounting surface so as to form an unordered arrangement.

24. The mounting board of claim 1, wherein the hooks and backing are integrally formed.
